(19) United States
(12) Patent Application Publication
(10) Pub. No.: US 2019/0138130 A1
(43) Pub. Date: May 9, 2019

(54) TOUCH CONTROL DEVICE

(71) Applicants: HYUNDAI MOTOR COMPANY, Seoul (KR); KIA MOTORS CORPORATION, Seoul (KR)

(72) Inventors: HeeJin RO, Seoul (KR); Gideok KWON, Seoul (KR); Donghee SEOK, Suwon-Si (KR); Jong Bok LEE, Suwon-Si (KR)

(21) Appl. No.: 16/182,039

(22) Filed: Nov. 6, 2018

(30) Foreign Application Priority Data
Nov. 8, 2017 (KR) 10-2017-0147688

(51) Int. Cl. G06F 3/044

(52) U.S. Cl. CPC G06F 3/044

(57) ABSTRACT

A touch control device includes a metal plate having a first surface on a top surface of the metal plate, a second surface on a bottom surface of the metal plate, and a plurality of signal transferring holes penetrating between the first surface and the second surface, a dielectric arranged to contact the second surface of the metal plate, and a sensor electrode arranged to contact the dielectric.

### CROSS-REFERENCE TO RELATED APPLICATION

This application is based on and claims priority under 35 U.S.C. § 119 to Korean Patent Application No. 10-2017-0147688 filed on Nov. 8, 2017, in the Korean Intellectual Property Office, the disclosure of which is incorporated herein by reference in its entirety.

### TECHNICAL FIELD

The present disclosure relates to a touch control device, and more particularly, to a touch control device with a metallic touch surface.

### BACKGROUND

Vehicles include a cluster for displaying driving functions and vehicle information, such as velocity of the vehicle, engine revolutions per minute, an amount of fuel or coolant, etc.

A vehicle basically runs on the road but also provides various functions, such as audio play, video play, navigation, air conditioning control, seat control, lighting control, etc.

Studies have been conducted on various input devices for facilitating safe and convenient manipulation of the functions of the vehicle, and among the input devices, a touch control device in particular has been increasingly used in consideration of the appearance and the user convenience of manipulation.

To implement the touch control device capable of being manipulated by touches, resistive, capacitive, surface acoustic wave, transmitter methods, etc., are used.

One example of the touch control device using a capacitive method includes crossing electrode patterns and detects an input position by sensing a change in capacitance between electrodes when an input means, such as a finger comes into contact with the touch control device. Another example of the touch control device applies the same electric potential of a phase to both terminals of a transparent conductive film and detects an input position by sensing a small current that flows when a capacitance is formed by an input means, such as a finger coming into contact with or approaching the touch control device.

### SUMMARY

The present disclosure provides a touch control device having a metallic outer surface to improve its appearance and durability.

The present disclosure also provides a touch control device that may be installed on the coating formed of a metal plate, such as a trim of a vehicle.

The present disclosure also provides a touch control device that may be stably operated not only at room temperature but also in a harsh condition such as at high or low temperature.

In accordance with one aspect of the present disclosure, a touch control device may comprises a metal plate having a first surface on a top surface of the metal plate, a second surface on a bottom surface of the metal plate, and a plurality of signal transferring holes penetrating between the first surface and the second surface, a dielectric arranged to contact the second surface of the metal plate, and a sensor electrode arranged to contact the dielectric.

The touch control device may further include a base plate supporting the sensor electrode.

The signal transferring holes may include a microscopic hole.

The signal transferring holes may further include a medium which fills the microscopic hole and induces a change in permittivity of the dielectric by an object approaching or contacting the metal plate.

The medium may include air.

The medium and the dielectric may have a same material.

The metal plate may be arranged to form the appearance of the inside of a vehicle.

The metal plate may make up the appearance of a vehicle.

The touch control device may further include a plurality of sensing areas, each dielectric is arranged separately for each sensing area, and the sensor electrode is arranged to correspond to the dielectric.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a perspective view of a touch control device, according to an embodiment of the present disclosure;

FIG. 2 is a cross-sectional view along line A-A′ of FIG. 1;

FIG. 3 is a cross-sectional view along line B-B′ of FIG. 1;

FIG. 4 is an enlarged view of portion C of a metal plate of FIG. 1;

FIG. 5 shows a state of a touch control device before a touch is made thereon, according to an embodiment of the present disclosure;

FIG. 6 shows a state of a touch control device when a touch is made thereon, according to an embodiment of the present disclosure; and

FIG. 7 shows a metal plate of a touch control device, according to an embodiment of the present disclosure.

FIG. 8 shows a touch control device placed inside e.g., a vehicle to be used as an input device.

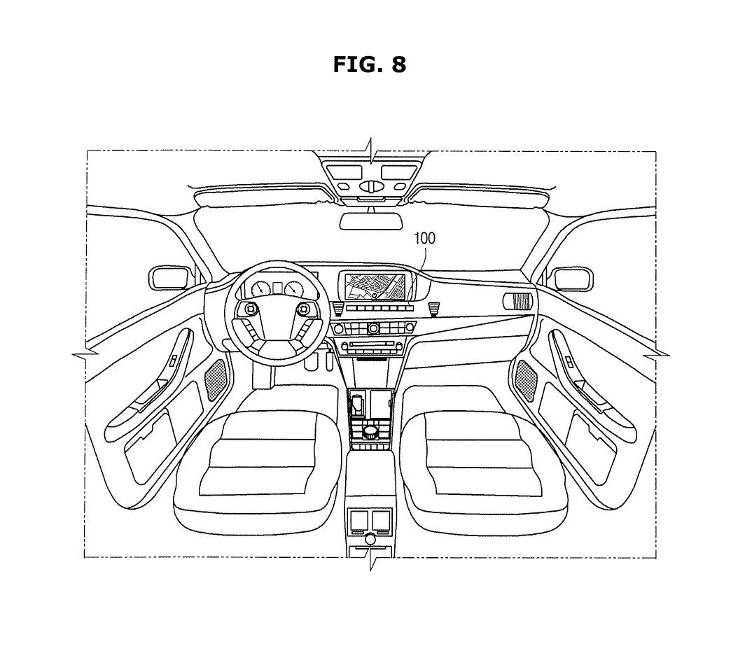

FIG. 9 shows a touch control device formed to be a portion of a trim of the vehicle.

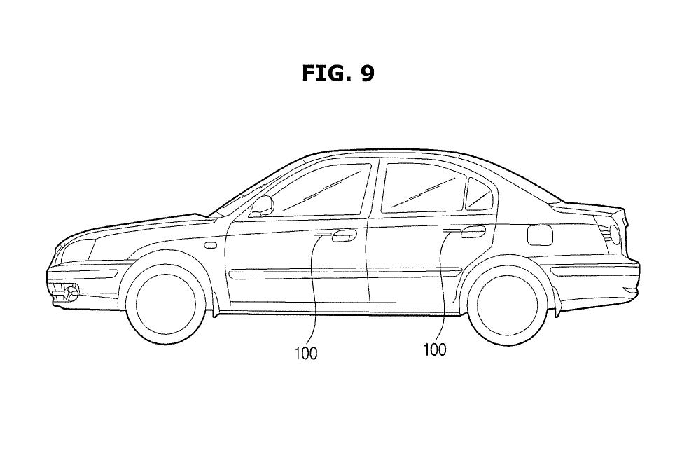

### DETAILED DESCRIPTION OF EXEMPLARY EMBODIMENTS

Reference will now be made in detail to embodiments, examples of which are illustrated in the accompanying drawings. The following description is provided to assist in a comprehensive understanding of exemplary embodiments of the disclosure as defined by the claims and their equivalents. It includes various specific details to assist in that understanding but these are to be regarded as merely exemplary. Accordingly, those of ordinary skilled in the art will recognize that various changes and modifications of the embodiments described herein can be made without departing from the scope and spirit of the disclosure.

A touch control device is a means for receiving signals by touch or contact (or proximity) of an input means, such as a finger of the user or a touch pen, and determining a position of the touch (or proximity).

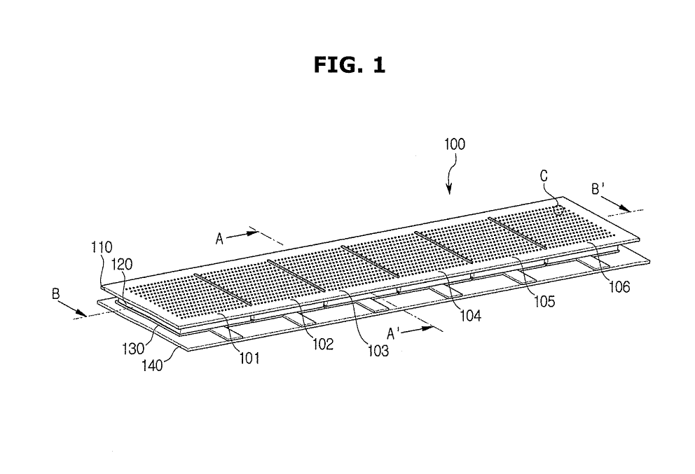

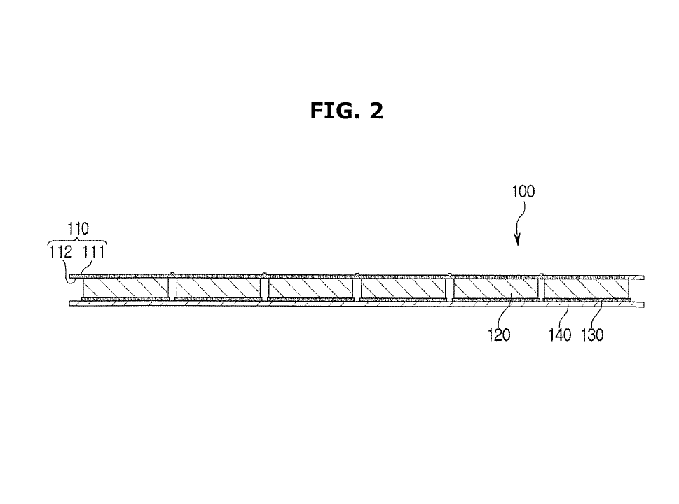

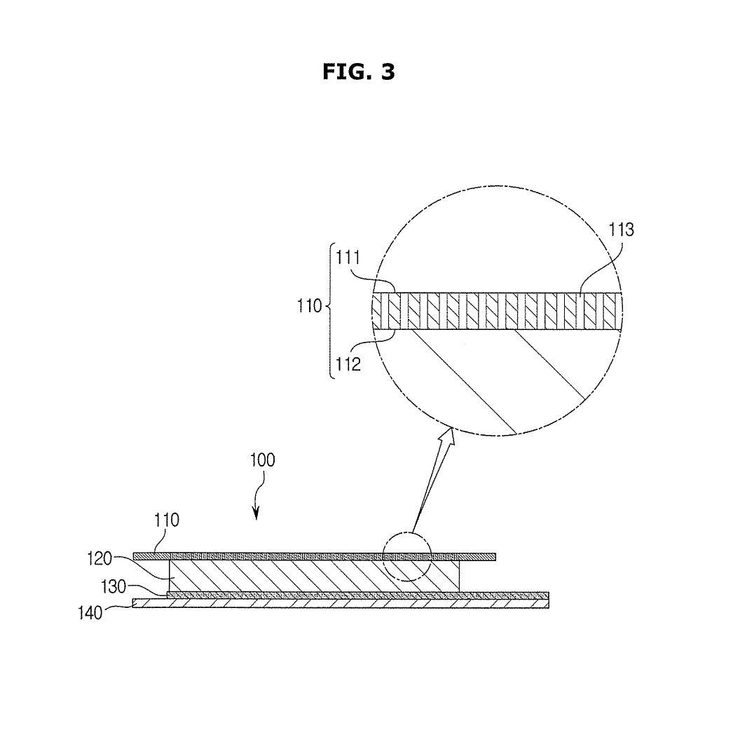

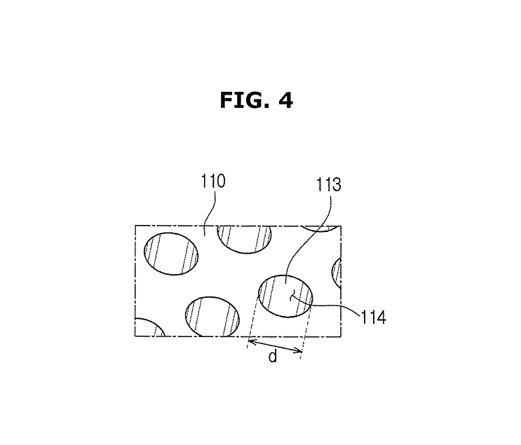

FIG. 1 is a perspective view of a touch control device, according to an embodiment of the present disclosure. FIG. 2 is a cross-sectional view along line A-A′ of FIG. 1. FIG. 3 is a cross-sectional view along line B-B′ of FIG. 1. FIG. 4 is an enlarged view of portion C of a metal plate of FIG. 1.

Referring to FIGS. 1 to 4, in an embodiment of the present disclosure, a touch control device 100 may include a metal plate 110, a dielectric 120, and a sensor electrode 130.

The metal plate 110 may be comprised of a board formed of a metal material, e.g., a ferroalloy such as stainless steel, or aluminum, or a non-ferrous alloy such as magnesium.

With respect to the accompanied drawings, the metal plate 110 may include a top surface 111 exposed to the outside, a bottom surface 112 on the opposite side of the top surface 111, and a plurality of signal transferring holes 113 formed to penetrate the top surface 111 and the bottom surface 112.

Each of the signal transferring holes 113 may include a microscopic hole 114 having a diameter d of a few micrometers to tens of micrometers and a medium that fills the microscopic hole 114 to induce a change of permittivity of the dielectric in response to an object approaching or contacting the metal plate 110.

The microscopic hole 114 may be formed in a method of laser processing, etching, punching, etc., and may be arranged with regular distribution. Since the microscopic hole 114 is quite small in size, the existence of the microscopic hole 114 may not be easily perceived by the person with his/her naked eyes. Accordingly, the metal plate 110 may apparently have an intact feeling of metallic luster and texture, which is unique to the metal.

The microscopic hole 114 may be filled with the medium. The medium may be air. In this case, the microscopic hole 114 may be formed to be empty space, which is filled with air.

The medium may be the same material as the dielectric 120, which will be described later, from another perspective. In this case, part of the dielectric 12 may fill the microscopic hole 114 by being moved thereto by the capillary action.

The dielectric 120 may be arranged underneath the metal plate 110. The dielectric 120 may be placed to make contact with the bottom surface 112 of the metal plate 110. The dielectric 120 may be formed of a material having a certain permittivity, and may be induced by the signal transferring holes 113 to be subject to a change in permittivity when coming into contact with a portion of the user's body.

Contact (or touch) may be defined herein to imply both direct contact and indirect contact. Specifically, direct contact means an event when an object touches the touch control device 100, and indirect contact means an event when the object approaches into a range in which the sensing patterns may detect the object although the touch control device 100 is not touched.

The sensor electrode 130 may be arranged underneath the dielectric 120 to detect a change in permittivity of the dielectric 120. The sensor electrode 130 may be arranged in a state of being in contact with the dielectric 120 in order to detect a change in permittivity of the dielectric 120.

The touch control device 100 may include a plurality of sensing areas 101 to 106, and the dielectric 120 and the sensor electrode 130 may be provided in the plural, each pair being arranged in each area of the plurality of sensing areas 101 to 106.

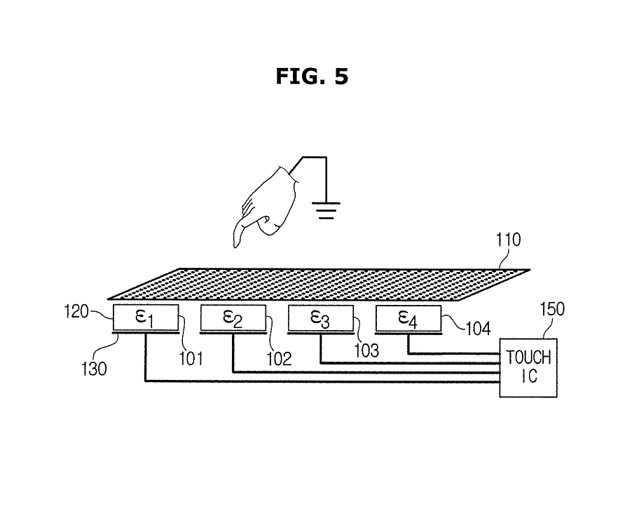

The sensor electrodes 130 may be connected to a touch Integrated Circuit (IC) 150 (see FIG. 5), and the touch IC 150 may detect a sensing area 101, 102, . . . , or 106 to be activated by the user by measuring a change in capacitance based on a change of permittivity through the respective sensor electrodes 130 by means of frequency change, voltage change, etc.

The sensor electrode 130 may be made of a conductive material, e.g., a metallic board or a film with a thin metallic layer formed thereon, or a combination thereof.

A base plate 140 may be arranged underneath the sensor electrode 130.

The base plate 140 is a structure to support the metal plate 110, the dielectric 120, and the sensor electrode 130, which may have an equal area to or a bit larger area than the area of the metal plate 110, the dielectric 120 and the sensor electrode 130 to support the components that constitute the touch control device 100 and may have enough strength to support what are arranged above the base plate 140.

Furthermore, the base plate 140 may be formed of a nonconductor of electricity in order not to influence the value output from the respective sensor electrodes 130. Otherwise, if the base plate 140 is formed of a conductor, it may be insulated from the sensor electrode 130.

The touch control device 100 may be placed inside e.g., a vehicle to be used as an input device. In this case, the touch control device 100 may be used as an input device to be manipulated by the driver or an input device for a fellow passenger.

Furthermore, the touch control device 100 in accordance with an embodiment of the present disclosure may be formed to be a portion of a trim of the vehicle. In this case, the metal plate 110 may be a board that makes up a trim of the vehicle.

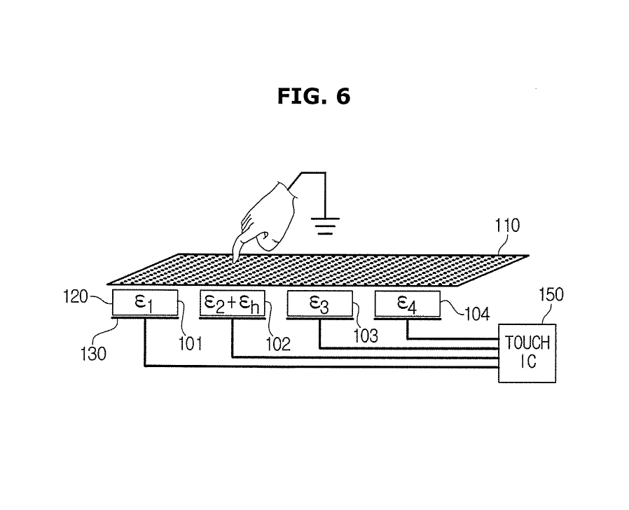

FIG. 5 shows a state of a touch control device before a touch is made thereon, according to an embodiment of the present disclosure. FIG. 6 shows a state of a touch control device when a touch is made thereon, according to an embodiment of the present disclosure.

A procedure of operation of a touch control device in accordance with an embodiment of the present disclosure will now be described with reference to FIGS. 5 and 6.

For convenience of explanation, an occasion when the touch control device 100 has four sensing areas 101 to 104 will be focused as an example. As shown in FIG. 5, if a finger of the user has not yet sufficiently approached but stays a distance away from the metal plate 110, the respective dielectrics 120 have their unique permittivity ε₁˜ε₄ and capacitance proportional to the permittivity. However, since the respective dielectrics 120 are electrically connected by the metal plate 110, all the dielectrics 120 have the same capacitance.

Even if the respective dielectrics 120 have the same permittivity, all the dielectrics 120 may have the same capacitance before a touch is made, and this state may be recognized by the touch IC 150 as an initial state in which no touch is made on the touch control device 100.

After that, if the user touches one of the sensing areas 101 to 104 with his/her finger to operate the touch control device 100 as shown in FIG. 6, the permittivity of the touched sensing area 102 is changed to have ε₂+εₕ as εₕ is added by the finger touch from the state in which all the sensing areas 101 to 104 of the entire dielectrics 120 maintain the same capacitance, and a change of capacitance from the change of permittivity is recognized by the touch IC 150, which may in turn recognize that an operation command is input to the touched area.

In this way, since a touch is recognized as a change of permittivity from a finger touch in the touched sensing area is reflected to the dielectric 120 and the sensing electrode 130, it is also possible to recognize multi-touch on the plurality of sensing areas.

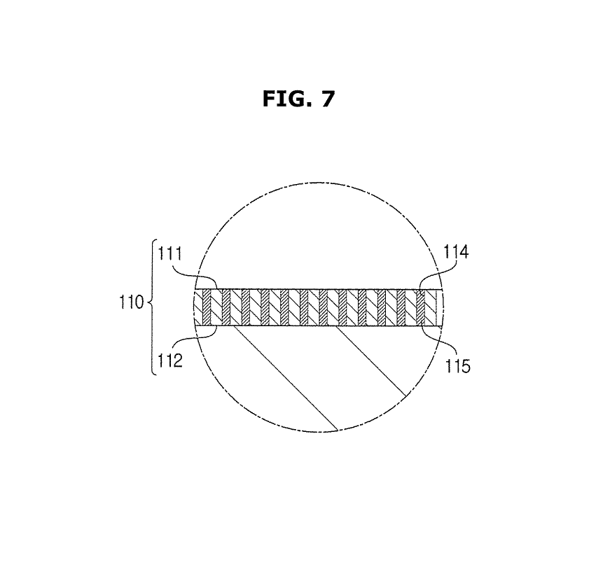

FIG. 7 shows a metal plate of a touch control device, according to an embodiment of the present disclosure.

In the embodiment, to improve touch recognition rate, the signal transferring holes 113 may be filled with a medium 115 having different permittivity from the dielectric 120 located underneath the metal plate 110. In this case, a resin may be used as the medium, which may fill the microscopic hole 114 (see FIG. 4) of the signal transferring holes 113 by the capillary action.

The medium 115 may not only make the touch-based change in permittivity of the dielectric 120 more sensitive but also play a role in preventing the microscopic hole 114 from being blocked with a contaminant and thus causing a decrease in sensitivity of touch or aesthetic contamination.

According to embodiments of the present disclosure, a touch control device is expected to gain the following effects:

First, the touch control device is expected to have improved appearance and durability because of having the metallic outer surface.

The touch control device may be applicable to a portion, such as a trim of a vehicle that may be exposed to the outside environment.

Furthermore, a capacitive touch gesture interface may be implemented on a metal surface, thereby providing the user with intuitive touch interface experience.

Moreover, the present disclosure may deal with a problem of attachment of a piezofilm, which occurs in implementing a method of recognizing the pressure applied on a metal surface using the piezofilm attached onto the rear side of the metal surface.

Several embodiments have been described above, but a person of ordinary skill in the art will understand and appreciate that various modifications can be made without departing the scope of the present disclosure. Thus, it will be apparent to those ordinary skilled in the art that the true scope of technical protection is only defined by the following claims.

What is claimed is:

1. A touch control device comprising:
a metal plate having:
a first surface on a top surface of the metal plate;
a second surface on a bottom surface of the metal plate; and
a plurality of signal transferring holes penetrating between the first surface and the second surface;
a dielectric arranged to contact the second surface of the metal plate; and
a sensor electrode arranged to contact the dielectric.

2. The touch control device of claim 1, further comprising: a base plate supporting the sensor electrode.

3. The touch control device of claim 1, wherein each of the signal transferring holes includes a microscopic hole.

4. The touch control device of claim 3, wherein each of the signal transferring holes further includes a medium which fills the microscopic hole and induces a change in permittivity of the dielectric by an object approaching or contacting the metal plate.

5. The touch control device of claim 4, wherein the medium comprises air.

6. The touch control device of claim 4, wherein the medium and the dielectric have a same material.

7. The touch control device of claim 1, wherein the metal plate is arranged to form the appearance of the inside of a vehicle.

8. The touch control device of claim 1, wherein the metal plate makes up the appearance of a vehicle.

9. The touch control device of claim 1, further comprising a plurality of sensing areas, each of which includes the dielectric,
wherein the plurality of sensing areas are spaced apart from each other, and
wherein the sensor electrode is arranged to correspond to the dielectric.
